(19) United States
(12) Patent Application Publication
(10) Pub. No.: US 2026/0127996 A1
(43) Pub. Date: May 7, 2026

(54) DISPLAY DEVICE, METHOD OF OPERATING THE DISPLAY DEVICE, AND ELECTRONIC DEVICE INCLUDING THE DISPLAY DEVICE

(71) Applicant: Samsung Display Co., Ltd., Yongin-si (KR)

(72) Inventors: Hyunho LIM, Yongin-si (KR); Yoosung KIM, Yongin-si (KR)

(73) Assignee: Samsung Display Co., Ltd., Yongin-si (KR)

(21) Appl. No.: 19/301,461

(22) Filed: Aug. 15, 2025

(30) Foreign Application Priority Data
Nov. 1, 2024 (KR) 10-2024-0153284

(51) Int. Cl. G09G 3/20

(52) U.S. Cl. CPC G09G 3/2092; G09G 2310/027; G09G 2320/06; G09G 2320/103; G09G 2330/021; G09G 2370/08

(57) ABSTRACT

A display device may include a display panel including pixels, a gate driver configured to output a gate signal to the pixels through a gate line extending in a first direction, a data driver configured to output a data voltage to the pixels through a data line extending in a second direction intersecting with the first direction, and a driving controller configured to the gate driver and the data driver, determine a same data region, of a sub-display region of a plurality of sub-display regions of the display panel parallel to the second direction, in which output image data of a previous frame is identical to output image data of a current frame, perform a low power mode operation which does not transmit the output image data corresponding the same data region to the data driver in the current frame.

### CROSS-REFERENCE TO RELATED APPLICATION(S)

This application claims priority under 35 USC § 119 to Korean Patent Application No. 10-2024-0153284 filed on Nov. 1, 2024, in the Korean Intellectual Property Office (KIPO), the entire disclosure of which is incorporated by reference herein.

### BACKGROUND

A display device may include a display panel and a display panel driver. The display panel may include gate lines, data lines, and/or pixels connected to the gate lines and the data lines. The display panel driver may include a gate driver which provides a gate signal to the gate lines, a data driver which provides a data voltage to the data lines, and/or a driving controller which controls the gate driver and the data driver.

Recently, The display device that performs a low power mode operation has been proposed when a data signal of a previous frame is identical to a data signal of a current frame. However, as a conventional display device only performs the low power mode operation for an entire display region, the conventional display device has a limitation that the conventional display device cannot perform the low power mode operation except when displaying the same still image from frame to frame.

### SUMMARY

Some example embodiments of the inventive concepts provide a display device which performs a low power mode operation for a sub-display region.

Some example embodiments of the inventive concepts provide a method of operation the display device.

Some example embodiments of the inventive concepts provide an electronic device including the display device.

However, some example embodiments of the inventive concepts are not limited to the above example embodiments, and may be variously extended without departing from the spirit and scope of the inventive concepts.

According to some example embodiments, a display device may include a display panel including pixels, a gate driver configured to output a gate signal to the pixels through a gate line extending in a first direction, a data driver configured to output a data voltage to the pixels through a data line extending in a second direction intersecting with the first direction, and a driving controller configured to control the gate driver and the data driver, determine a same data region, of a sub-display region of a plurality of sub-display regions of the display panel parallel to the second direction, in which output image data of a previous frame is identical to output image data of the current frame, and perform a low power mode operation which does not transmit the output image data corresponding the same data region to the data driver in the current frame.

In some example embodiments, the driving controller may be further configured to perform the low power mode operation by turning off at least one of component included in the data driver.

In some example embodiments, the data driver may include a plurality of receiving blocks, each receiving block of the plurality of receiving blocks corresponding to a respective sub-display region of the plurality of sub-display regions, each receiving block of the plurality of receiving blocks may be configured to receive the output image data corresponding to the respective sub-display region, and the driving controller may be configured to turn off a receiving block, of the plurality of receiving blocks, corresponding to the same data region in the current frame.

In some example embodiments, when driving controller may be further configured to perform the low power mode operation by turning off at least one of component included in the driving controller.

In some example embodiments, the driving controller may include a plurality of transmitting blocks, each transmitting block of the plurality of transmitting blocks corresponding to a respective sub-display region of the plurality of sub-display regions, each transmitting block of the plurality of transmitting blocks may be configured to transmit the output image data corresponding to the respective sub-display region to the data driver, and the driving controller may be configured to turn off a transmitting block, of the plurality of transmitting blocks, corresponding to the same data region in the current frame.

In some example embodiments, the driving controller is further configured to perform the low power mode operation by turning off at least one component included in the driving controller.

In some example embodiments, the data driver may include a plurality of receiving blocks, each receiving block of the plurality of receiving blocks corresponding to a respective sub-display region of the plurality of sub-display regions, each receiving block of the plurality of receiving blocks may be configured to receive the output image data corresponding to the respective of the sub-display region, the driving controller may include a plurality of transmitting blocks, each transmitting block of the plurality of transmitting blocks corresponding to a respective sub-display region of the plurality of sub-display regions, each transmitting block of the plurality of transmitting blocks may be configured to transmit the output image data corresponding to the respective sub-display region to a respective receiving block of the plurality of receiving blocks, and the driving controller may be configured to turn off a receiving block, of the plurality of receiving blocks, corresponding to the same data region in the current frame, and turn off a transmitting block, of the plurality of transmitting blocks, corresponding to the same data region in the current frame.

In some example embodiments, the driving controller may be configured to transmit, in a blank period of the previous frame, a plurality of protocol signals to the data driver through a plurality of data transmitting lines configured to transmit the output image data in the blank period of the previous frame, each protocol signal of the plurality of protocol signals corresponding to a respective sub-display region of the plurality of sub-display regions, and each protocol signal of the plurality of protocol signals may include a low power mode entrance signal and a low power mode termination signal indicating whether to perform the low power mode operation for a respective dub-display region of the plurality of sub-display regions in the current frame.

In some example embodiments, the driving controller may be configured to perform the low power mode operation for a first target sub-display region, of the plurality of sub-display regions, corresponding to the low power mode entrance signal having an activation level in the current frame.

In some example embodiments, the driving controller may be configured to terminate the low power mode operation for a second target sub-display region, of the plurality of sub-display regions, corresponding to the low power mode termination signal having an activation level in the current frame.

In some example embodiments, the driving controller may be configured to transmit, to the data driver through signal transmitting lines different from data transmitting lines for transmitting the output image data, a plurality of low power signals, each low power signal of the plurality of low power signals indicating whether to perform the low power mode operation for a respective sub-display region of the plurality of sub-display regions.

In some example embodiments, the driving controller may be configured to perform the low power mode operation for a first target sub-display region, of the plurality of sub-display regions, corresponding to a first low power signal, of the plurality of low power signals in response to the first low power signal having an activation level, and may perform a normal mode operation in which the data driver receives the output image data for a second target sub-display region, of the plurality of sub-display regions, corresponding to a second low power signal of the plurality of low power signals in response to the second low power signal having a deactivation level.

According to some example embodiments, a method of operating a display device, in which a gate line extends in a first direction and a data line extends in a second direction intersecting with the first direction, may include determining a same data region, of a sub-display region of a plurality of sub-display regions of a display panel of the display device, in which output image data of a previous frame is identical to output image data of a current frame, and performing a low power mode operation in which the output image data corresponding to the same data region is not transmitted to a data driver in the current frame

In some example embodiments, the performing the low power mode operation may include turning off at least one component included in the data driver.

In some example embodiments, the data driver may include a plurality of receiving blocks, each receiving block of the plurality of receiving blocks corresponding to a respective sub-display region of the plurality of sub-display regions, and the method may further include, receiving, by the plurality of receiving blocks, the output image data corresponding the respective sub-display region, and turning off a receiving block, of the plurality of receiving blocks, corresponding to the same data region in the current frame.

In some example embodiments, the method may further include performing the low power mode operation by turning off at least one component included in a driving.

In some example embodiments, the driving controller may include a plurality of transmitting blocks, each transmitting block of the plurality of transmitting blocks corresponding to respective sub-display region of the plurality of sub-display regions, and the method may further include transmitting, by each transmitting block of the plurality of transmitting blocks, the output image data corresponding to the respective sub-display region, to the data driver, and turning off a transmitting block, of the plurality of transmitting blocks, corresponding to the same data region in the current frame.

In some example embodiments, the method may further include transmitting, by a driving controller in a blank period of the previous frame, a plurality of protocol signals, each protocol signal of the plurality of protocol signals corresponding to a respective sub-display region of the plurality of sub-display regions, to the data driver of the display device through data transmitting lines for transmitting the output image data corresponding to each sub-display region of the plurality of sub-display regions in a blank period of the previous frame, each protocol signal of the plurality of protocol signals may include a low power mode entrance signal and a low power mode termination signal indicating whether to perform the low power mode operation for a respective sub-display region of the plurality of sub-display regions in the current frame.

In some example embodiments, the performing the low power mode operation may include performing the low power mode operation for a first target sub-display region, of the plurality of sub-display regions, corresponding to the low power mode entrance signal having an activation level, and the method may further include terminating the low power mode operation for a second target sub-display region, of the plurality of sub-display regions, corresponding to the low power mode termination signal having the activation level in the current frame.

According to some example embodiments, an electronic device may include a display panel including pixels, a gate driver configured to output a gate signal to the pixels through a gate line extending in a first direction, a data driver configured to output a data voltage to the pixels through a data line extending in a second direction, a driving controller configured to control the gate driver and the data driver based on a control signal and an input image data group, and a processor configured to generate the control signal and the input image data group. The driving controller may be further configured to determine a same data region, of a sub-display region of a plurality of sub-display regions of the display panel parallel to the second direction, in which output image data of a previous frame is identical to output image data of a current frame, and perform a low power mode operation which does not transmit the output image data corresponding the same data region to the data driver in the current frame.

According to some example embodiments, the display device may reduce power consumption which is consumed by the driving controller and the data driver by causing the driving controller to determine the same data region of the display panel and not transmit data signals for the same data region to the data driver. For example, when the driving controller does not transmit the data signals for the same data region to the data driver, at least one component included in the driving controller and the data driver may be turned off in a same data period allocated to the same data region of the display panel among a data signal transmitting period.

According to some example embodiments, the method of operating the display device may reduce the power consumption which is consumed by the driving controller and the data driver. Accordingly, the method of operating the display device may reduce power consumption of the display device.

### BRIEF DESCRIPTION OF THE DRAWINGS

Illustrative, non-limiting example embodiments will be more clearly understood from the following detailed description in conjunction with the accompanying drawings.

FIG. 1 is a block diagram illustrating a display device according to some example embodiments.

FIG. 2 is a diagram illustrating a display panel included in the display device of FIG. 1 which is divided into display regions.

FIG. 3 is a diagram illustrating some example embodiments of a transmitter group of a driving controller included in the display device of FIG. 1 and a receiver group of a data driver included in the display device of FIG. 1.

FIG. 4 is a diagram illustrating some example embodimentsof a transmitting block of a transmitting block group included in the transmitter group of FIG. 3 and a receiving block of a receiving block group included in the receiver group of FIG. 3.

FIG. 5 is a block diagram illustrating some example embodimentsof the data driver included the display device of FIG. 1.

FIG. 6 is a diagram illustrating determining the same data region of the display panel included in the display device of FIG. 1.

FIG. 7 is a timing diagram illustrating some example embodimentsof an operation for the same data region of the display panel performed by the data driver included in the display device of FIG. 1.

FIG. 8 is a flow chart illustrating a method of operating the display device of FIG. 1.

FIG. 9 is a diagram illustrating some example embodimentsof a transmitting block of a transmitting block group included in the transmitter group of FIG. 3 and a receiving block of a receiving block group included in the receiver group of FIG. 3.

FIG. 10 is a block diagram illustrating a display device according to some example embodiments.

FIG. 11 is a timing diagram illustrating some example embodimentsof an operation for the same data region of a display panel performed by a data driver included in the display device of FIG. 10.

FIG. 12 is a diagram illustrating determining the same data region of the display panel included in the display device of FIG. 1.

FIG. 13 is a block diagram illustrating an electronic device according to some example embodiments.

### DETAILED DESCRIPTION

Hereinafter, display devices in accordance with some example embodiments will be described in more detail with reference to the accompanying drawings. The same reference numerals are used for the same components in the drawings, and redundant descriptions of the same components will be omitted.

It will be understood that elements and/or properties thereof may be recited herein as being “the same” or “equal” as other elements, and it will be further understood that elements and/or properties thereof recited herein as being “identical” to, “the same” as, or “equal” to other elements may be “identical” to, “the same” as, or “equal” to or “substantially identical” to, “substantially the same” as or “substantially equal” to the other elements and/or properties thereof. Elements and/or properties thereof that are “substantially identical” to, “substantially the same” as or “substantially equal” to other elements and/or properties thereof will be understood to include elements and/or properties thereof that are identical to, the same as, or equal to the other elements and/or properties thereof within manufacturing tolerances and/or material tolerances. Elements and/or properties thereof that are identical or substantially identical to and/or the same or substantially the same as other elements and/or properties thereof may be structurally the same or substantially the same, functionally the same or substantially the same, and/or compositionally the same or substantially the same.

It will be understood that elements and/or properties thereof described herein as being “substantially” the same and/or identical encompasses elements and/or properties thereof that have a relative difference in magnitude that is equal to or less than 10%. Further, regardless of whether elements and/or properties thereof are modified as “substantially,” it will be understood that these elements and/or properties thereof should be construed as including a manufacturing or operational tolerance (e.g., ±10%) around the stated elements and/or properties thereof.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%. Further, regardless of whether numerical values or shapes are modified as “about” or “substantially,” it will be understood that these values and shapes should be construed as including a manufacturing or operational tolerance (e.g., ±10%) around the stated numerical values or shapes.

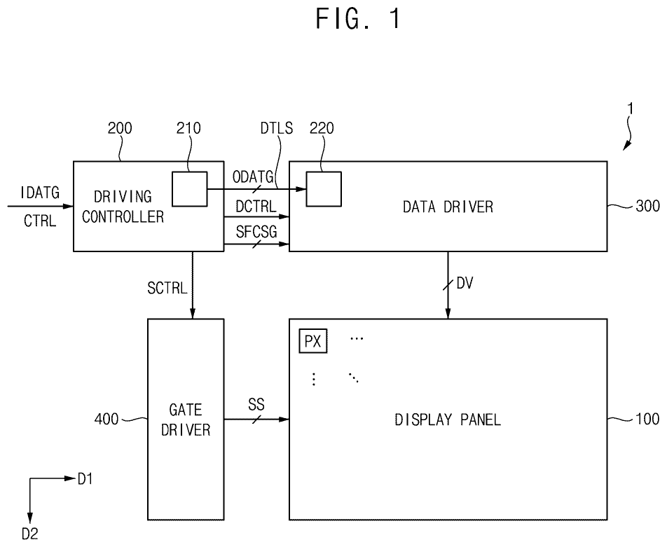

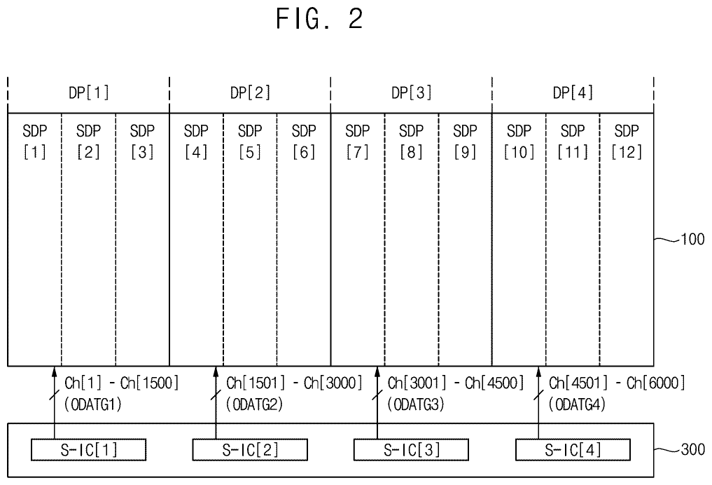

FIG. 1 is a block diagram illustrating a display device 1 according to some example embodiments and FIG. 2 is a diagram illustrating a display panel 100 included in the display device 1 of FIG. 1 which is divided into display regions DP.

Referring to FIGS. 1 and 2, the display device 1 may include the display panel 100 which includes pixels PX, a gate driver 400 which provides gate signals SS to the pixels PX, a data driver 300 which provides data voltages DV to the pixels PX, and/or a driving controller 200 which controls the gate driver 400 and/or the data driver 300.

The display panel 100 may include gate lines which transmit the gate signals SS to the pixels PX and/or data lines which transmit the data voltages DV to the pixels PX.

The gate driver 400 may generate the gate signals SS based on a gate control signal SCTRL which is received from the driving controller 200 and may provide the gate signals SS to the pixels PX row by row through the gate lines. In some example embodiments, the gate lines may extend in a first direction D1. In some example embodiments, the gate control signal SCTRL may include a gate start signal and/or a gate clock signal, but the gate control signal SCTRL is not limited thereto. In some example embodiments, the gate driver 400 may be integrated or formed in a peripheral area adjacent to a display region of the display panel 100. In other embodiment, the gate driver 400 may be integrated or formed in at least a portion of the display region of the display panel 100. In some example embodiments, the gate driver 400 may be implemented in a form of an integrated circuit.

The driving controller 200 (e.g. a timing driving controller (TCON)) may receive an input image data group IDATG and/or a control signal CTRL from an external host processor (e.g. an application processor (AP), a graphic processing unit (GPU), etc.). For example, the input image data group IDATG may be RGB image data including red image data, green image data, and/or blue image data, but the input image data group IDATG is not limited thereto. For example, the control signal CTRL may include a vertical synchronizing signal, a horizontal synchronizing signal, an input data enable signal, and/or a master clock signal, the control signal CTRL is not limited thereto.

The driving controller 200 may control an operation of the gate driver 400 by providing the gate control signal SCTRL to the gate driver 400 and may control an operation of the data driver 300 by providing an output image data group ODATG, a data control signal DCTRL, and/or a forward signal group SFCSG to the data driver 300. For example, the driving controller 200 may include a transmitter group 210 which outputs the output image data group ODATG.

The data driver 300 may generate the data voltages DV based on the output image data group ODATG received from the driving controller 200 and/or the data control signal DCTRL and may provide the data voltages DV to the pixels PX through the data lines. The data driver 300 may include a receiver group 220 which receives the output image data group ODATG. In some example embodiments, the data lines may extend in a second direction D2 crossing the first direction D1.

The receiver group 220 of the data driver 300 may receive the output image data group ODATG through a data transmitting line group DTLS. In some example embodiments, the output image data group ODATG may be transmitted in a form of a clock embedded data signal where a clock signal is embedded in the output image data group ODATG.

The data driver 300 may receive the forward signal group SFCSG indicating that a clock training pattern is being transmitted. In some example embodiments, the data driver 300 may include integrated circuits and a line which the forward signal group SFCSG is transmitted may be shared among the integrated circuits. The line which the forward signal group SFCSG is transmitted may be referred to as a shared forward channel. In some example embodiments, the data driver 300 may be implemented as a single integrated circuit. In some example embodiments, the data driver 300 and the driving controller 200 may be implemented as a single integrated circuit and the single integrated circuit which includes the data driver 300 and the driving controller 200 may be referred to as a timing controller embedded data driver (TED).

As illustrated in FIG. 2, the display panel 100 may be divided into display regions DP which are parallel to the second direction D2. For example, the data driver 300 may include source drivers S-IC. For convenience of explanation, it is assumed that the display panel 100 is divided into first to fourth display regions DP[1]1 to DP[4], the data driver 300 includes first to fourth source drivers S-IC[1] to S-IC[4], and each of the first to fourth display regions DP[1]1 to DP[4] is connected to the data driver 300 through 1500 channels Ch.

The first to fourth source drivers S-IC[1] to S-IC [4] may be respectively connected to the first to fourth display regions DP[1]1 to DP[4] through the channels Ch. For example, the first source driver S-IC[1] may be connected to the first display region DP[1] through 1st to 1500th channels Ch[1] to Ch[1500]. The second source driver S-IC[2] may be connected to the second display region DP[2] through 1501st to 1500th channels Ch[1501] to Ch[3000]. The third source driver S-IC[3] may be connected to the third display region DP[3] through 3001st to 4500th channels Ch[3001] to Ch[4500]. The fourth source driver S-IC[4] may be connected to the fourth display region DP[4] through 4501st to 6000th channels Ch[4501] to Ch[6000].

The output image data group ODATG may be one of first to fourth output image data groups ODATG1 to ODATGE4 corresponding to each of the first to fourth display regions DP[1]1 to DP[4]. For example, the first source driver S-IC[1] may generate the data voltages DV for the first display region DP[1] based on the first output image data group ODATG1. In addition, the second source driver S-IC[2] may generate the data voltages DV for the second display region DP[2] based on the second output image data group ODATG2. In addition, the third source driver S-IC[3] may generate the data voltages DV for the third display region DP[3] based on the third output image data group ODATG3. In addition, the fourth source driver S-IC[4] may generate the data voltages DV for the fourth display region DP[4] based on the fourth output image data group ODATG4.

The first display region DP[1] may be divided into first to third sub-display regions SDP[1] to SDP[3] which are parallel to the second direction D2. The first sub-display region SDP[1] may be connected to the first source driver S-IC[1] through the 1st to 500th channels Ch[1] to Ch[500]. The second sub-display region SDP[2] may be connected to the first source driver S-IC[1] through the 501st to 1000th channels Ch[501] to Ch[1000]. The third sub-display region SDP[3] may be connected to the first source driver S-IC[1] through the 1001st to 1500th channels Ch[1001] to Ch[1500].

The second display region DP[2] may be divided into fourth to sixth sub-display regions SDP[4] to SDP[6] which are parallel to the second direction D2. The fourth sub-display region SDP[4] may be connected to the second source driver S-IC[2] through the 1501st to 2000th channels Ch[1501] to Ch[2000]. The fifth sub-display region SDP[5] may be connected to the second source driver S-IC[2] through the 2001st to 2500th channels Ch[2001] to Ch[2500]. The sixth sub-display region SDP[6] may be connected to the second source driver S-IC[2] through the 2501st to 3000th channels Ch[2501] to Ch[3000].

The third display region DP[3] may be divided into seventh to ninth sub-display regions SDP[7] to SDP[9] which are parallel to the second direction D2. The seventh sub-display region SDP[7] may be connected to the third source driver S-IC[3] through the 3001st to 3500th channels Ch[3001] to Ch[3500]. The eighth sub-display region SDP[8] may be connected to the third source driver S-IC[3] through the 3501st to 4000th channels Ch[3501] to Ch[4000]. The ninth sub-display region SDP[9] may be connected to the third source driver S-IC[3] through the 4001st to 4500th channels Ch[4001] to Ch[4500].

The fourth display region DP[4] may be divided into tenth to twelfth sub-display regions SDP[10] to SDP[12] which are parallel to the second direction D2. The tenth sub-display region SDP[10] may be connected to the fourth source driver S-IC[4] through the 4501st to 5000th channels Ch[4501] to Ch[5000]. The eleventh sub-display region SDP[11] may be connected to the fourth source driver S-IC[4] through the 5001st to 5500th channels Ch[5001] to Ch[5500]. The twelfth sub-display region SDP[12] may be connected to the fourth source driver S-IC[4] through the 5501st to 6000th channels Ch[5501] to Ch[6000].

The driving controller 200 may determine a same data region in which the output image of a previous frame and an output image of a current frame is the same among the first to twelfth sub-display regions SDP[1] to SDP[12]. The output image data group ODATG may include output image data. That is, the driving controller 200 may compare the output image data of a previous frame and the output image data of a current frame for each, or one or more, of the first to twelfth sub-display regions SDP[1] to SDP[12] based on the output image data corresponding to the first to twelfth sub-display regions SDP[1] to SDP[12], and may determine a same data region in which the output image data of the previous frame is identical to the output image data of the current frame among the first to twelfth sub-display regions SDP[1] to SDP[12]. The driving controller 200 may determine whether the previous frame is identical to the output image data of the current frame according to any known method. The display device 1 may perform a low power mode operation for the same data region. Accordingly, power consumption of the display device 1 may be reduced.

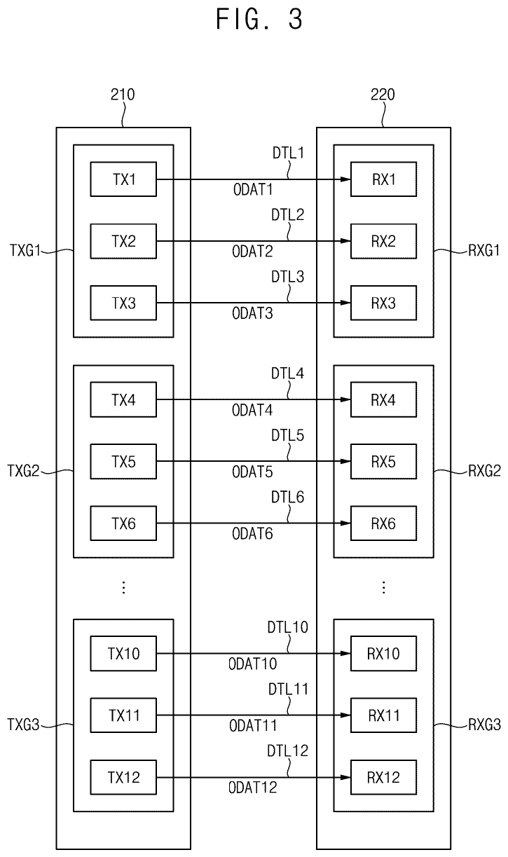

FIG. 3 is a diagram illustrating some example embodiments of the transmitter group 210 of the driving controller 200 included in the display device 1 of FIG. 1 and the receiver group 220 of the data driver 300 included in the display device 1 of FIG. 1.

Referring to FIG. 3, the transmitter group 210 may include transmitting block groups TXG. The receiver group 220 may include receiving block group RXG. That is, the transmitter group 210 may include first to fourth transmitting block groups TXG1 to TXG4 corresponding to the first to fourth display regions DP[1] to DP[4]. The receiver group 220 may include first to fourth receiving block groups RXG1 to RXG4 corresponding to the first to fourth display regions DP[1] to DP[4].

Each, or one or more, of the first to fourth transmitting block groups TXG1 to TXG4 may include transmitting blocks TX. Each, or one or more, of the first to fourth receiving block groups RXG1 to RXG4 may include receiving blocks RX. For convenience of explanation, it is assumed that each of the first to fourth transmitting block groups TXG1 to TXG4 includes 3 transmitting blocks TX and each of the first to fourth receiving block groups RXG1 to RXG4 includes 3 receiving blocks RX.

The first transmitting block group TXG1 may include first to third transmitting blocks TX1 to TX3. The second transmitting block group TXG2 may include fourth to sixth transmitting blocks TX4 to TX6. The third transmitting block group TXG3 may include seventh to ninth transmitting blocks TX7 to TX9. The fourth transmitting block group TXG4 may include tenth to twelfth transmitting blocks TX10 to TX12.

The first receiving block group RXG1 may include first to third receiving blocks RX1 to RX3. The second receiving block group RXG2 may include fourth to sixth receiving blocks RX4 to RX6. The third receiving block group RXG3 may include seventh to ninth receiving blocks RX7 to RX9. The fourth receiving block group RXG4 may include tenth to twelfth receiving blocks RX10 to RX12.

The first output image data group ODATG1 may include first to third output image data ODAT1 to ODAT3. The second output image data group ODATG2 may include fourth to sixth output image data ODAT4 to ODAT6. The third output image data group ODATG3 may include seventh to ninth output image data ODAT7 to ODAT9. The fourth output image data group ODATG4 may include tenth to twelfth output image data ODAT10 to ODAT12.

The first to third output image data ODAT1 to ODAT3 may correspond to the first to third sub-display regions SDP[1] to SDP[3]. For example, the first output image data ODAT1 may correspond the first sub-display region SDP[1]. For example, the second output image data ODAT2 may correspond to the second sub-display region SDP[2]. The third output image data ODAT3 may correspond to the third sub-display region SDP[3].

The fourth to sixth output image data ODAT4 to ODAT6 may correspond to the fourth to sixth sub-display regions SDP[4] to SDP[6]. For example, the fourth output image data ODAT4 may correspond the fourth sub-display region SDP[4]. For example, the fifth output image data ODAT5 may correspond to the fifth sub-display region SDP[5]. The sixth output image data ODAT6 may correspond to the sixth sub-display region SDP[6].

The seventh to ninth output image data ODAT7 to ODAT9 may correspond to the seventh to ninth sub-display regions SDP[7] to SDP[9]. For example, the seventh output image data ODAT7 may correspond the seventh sub-display region SDP[7]. For example, the eighth output image data ODAT8 may correspond to the eighth sub-display region SDP[8]. The ninth output image data ODAT9 may correspond to the ninth sub-display region SDP[9].

The tenth to twelfth output image data ODAT10 to ODAT12 may correspond to the tenth to twelfth sub-display regions SDP[10] to SDP[12]. For example, the tenth output image data ODAT10 may correspond the tenth sub-display region SDP[10]. For example, the eleventh output image data ODAT11 may correspond to the eleventh sub-display region SDP[11]. The twelfth output image data ODAT12 may correspond to the twelfth sub-display region SDP[12].

The data transmitting line group DTLS may include first to twelfth data transmitting lines DTL1 to DTL12.

The first transmitting block group TXG1 may transmit the first output image data group ODATG1 to the first receiving block group RXG1 through the data transmitting line DTL. For example, the first transmitting block TX1 may transmit the first output image data ODAT1 to the first receiving block RX1 through the first data transmitting line DTL1. The second transmitting block TX2 may transmit the second output image data ODAT2 to the second receiving block RX2 through the second data transmitting line DTL2. The third transmitting block TX3 may transmit the third output image data ODAT3 to the third receiving block RX3 through the third data transmitting line DTL3.

The second transmitting block group TXG2 may transmit the second output image data group ODATG2 to the second receiving block group RXG2 through the data transmitting line DTL. For example, the fourth transmitting block TX4 may transmit the fourth output image data ODAT4 to the fourth receiving block RX4 through the fourth data transmitting line DTL4. The fifth transmitting block TX5 may transmit the fifth output image data ODAT5 to the fifth receiving block RX5 through the fifth data transmitting line DTL5. The sixth transmitting block TX6 may transmit the sixth output image data ODAT6 to the sixth receiving block RX6 through the sixth data transmitting line DTL6.

The third transmitting block group TXG3 may transmit the third output image data group ODATG3 to the third receiving block group RXG3 through the data transmitting line DTL. For example, the seventh transmitting block TX7 may transmit the seventh output image data ODAT7 to the seventh receiving block RX7 through the seventh data transmitting line DTL7. The eighth transmitting block TX8 may transmit the eighth output image data ODAT8 to the eighth receiving block RX8 through the eighth data transmitting line DTL8. The ninth transmitting block TX9 may transmit the ninth output image data ODAT9 to the ninth receiving block RX9 through the ninth data transmitting line DTL9.

The fourth transmitting block group TXG4 may transmit the fourth output image data group ODATG4 to the fourth receiving block group RXG4 through the data transmitting line DTL. For example, the tenth transmitting block TX10 may transmit the tenth output image data ODAT10 to the tenth receiving block RX10 through the tenth data transmitting line DTL10. The eleventh transmitting block TX11 may transmit the eleventh output image data ODAT11 to the eleventh receiving block RX11 through the eleventh data transmitting line DTL11. The twelfth transmitting block TX12 may transmit the twelfth output image data ODAT12 to the twelfth receiving block RX12 through the twelfth data transmitting line DTL12.

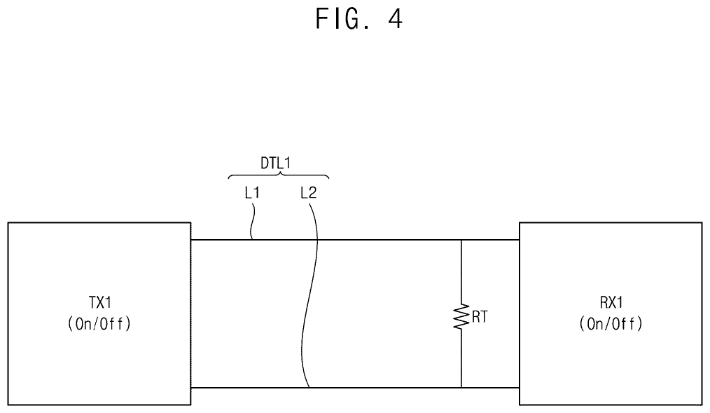

FIG. 4 is a diagram illustrating some example embodimentsof the transmitting block TX of the transmitting block group TXG included in the transmitter group 210 of FIG. 3 and the receiving block RX of the receiving block group RXG included in the receiver group 220 of FIG. 3.

Referring to FIG. 4, the transmitting block TX may be connected to the receiving block RX through the data transmitting line DTL. For convenience of explanation, some example embodimentswill be described with respect to the first transmitting block TX1, the first receiving block RX1, and the first data transmitting line DTL1.

The first transmitting block TX1 may be connected to the first receiving block RX1 through the first data transmitting line DTL1.

The first data transmitting line DTL1 may include a first line L1, a second line L2, and/or a load resistor RT. A first electrode of the load resistor RT may be connected to the first line L1 and/or a second electrode of the load resistor RT may be connected to the second line L2.

The first transmitting block TX1 and the first receiving block RX1 may be individually turned on or off. For example, the first transmitting block TX1 may be turned on and the first receiving block RX1 may be turned off. For example, the first transmitting block TX1 may be turned off and the first receiving block RX1 may be turned on. For example, the first transmitting block TX1 may be turned off and the first receiving block RX1 may be turned off.

When the first transmitting block TX1 and/or the second receiving block RX1 are/is turned off, the first output image data ODAT1 may not be transmitted to the data driver 300.

In some example embodiments, the output image for the first sub-display region SDP[1] may be the same in the previous frame and the current frame. For example, the first output image data ODAT1 for the first sub-display region SDP[1] may be the same in the previous frame and the current frame. According to some example embodiments, the first sub-display region SDP[1] may be the same data region and the driving controller 200 may determine the first sub-display region SDP[1] as the same data region. According to some example embodiments, the first transmitting block TX1, which transmits the first output image data ODAT1 from the driving controller 200 to the data driver 300, and/or the first receiving block RX1, which receives the first output image data ODAT1 transmitted by the first transmitting block TX1, may be turned off. According to some example embodiments, the first output image data ODAT1 may not be transmitted to the data driver 300.

For example, when the first output image data ODAT1 for the first sub-display region SDP[1] is the same in the previous frame and the current frame, the display device 1 may perform the low power mode operation for the first sub-display region SDP[1] and may perform a normal mode operation for the second to twelfth sub-display regions SDP[2] to SDP[12]. According to some example embodiments, the first output image data ODAT1 may not be transmitted to the data driver 300 in the current frame. As the first output image data ODAT1 is not transmitted to the data driver 300, the driving controller 200 and the data driver 300 may not consume power. For example, the power consumption of the display device 1 including the driving controller 200 and the data driver 300 may be reduced.

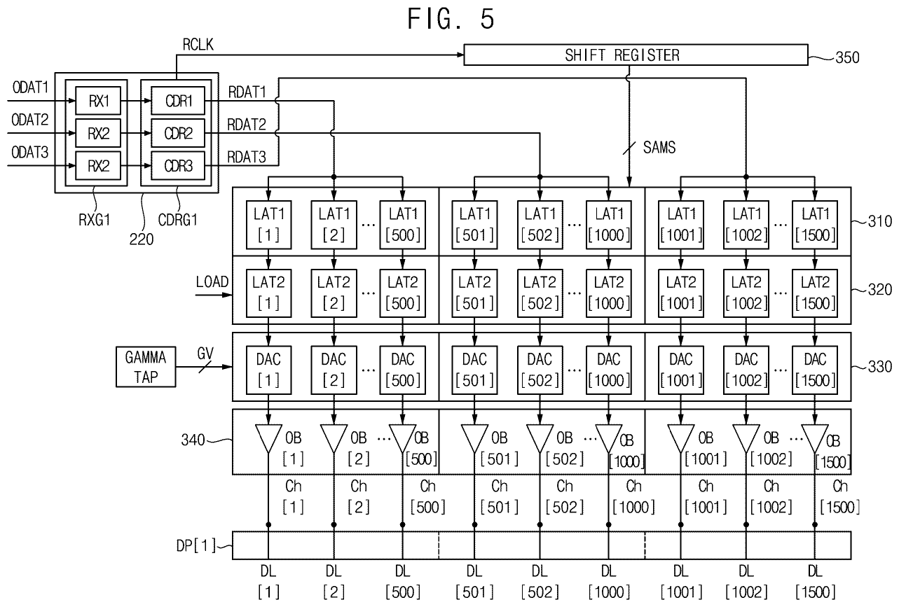

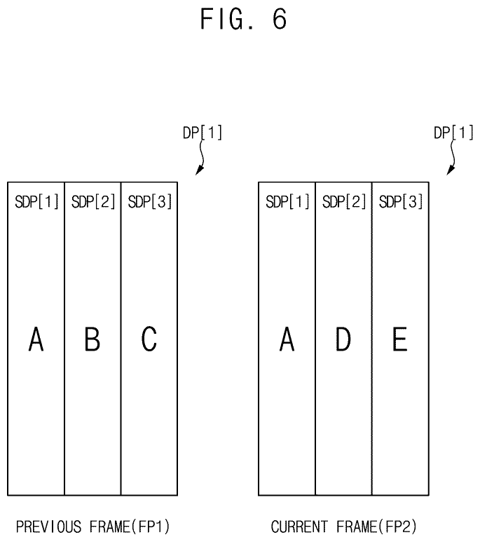

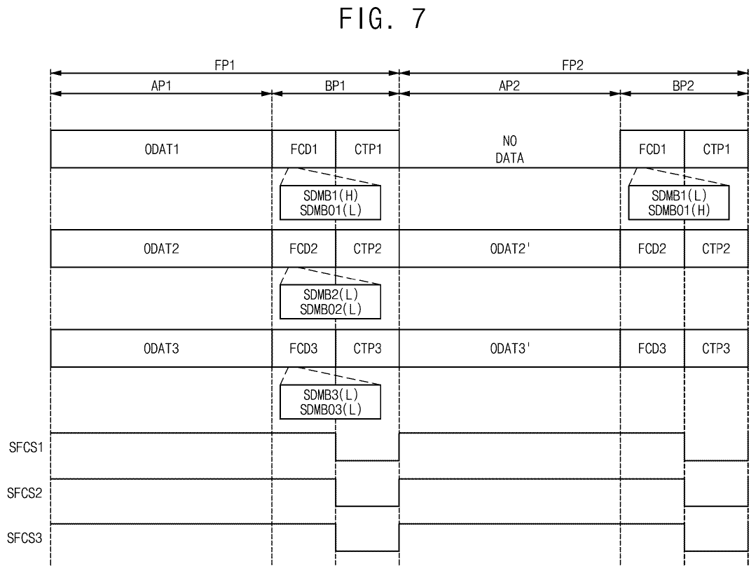

FIG. 5 is a block diagram illustrating some example embodimentsof the data driver 300 included in the display device 1 of FIG. 1, FIG. 6 is a diagram illustrating determining the same data region of the display panel 100 included in the display device 1 of FIG. 1, and FIG. 7 is a timing diagram illustrating some example embodimentsof an operation for the same data region of the display panel 100 performed by the data driver 300 included in the display device 1 of FIG. 1.

As components and operating methods of each of the first to fourth source driver S-IC[1] to S-IC[4] are substantially the same, some example embodimentswill be described with respect to the first source driver S-IC[1] and the explanation for the second to fourth source drivers S-IC[2] to S-IC[4] will be omitted.

Referring to FIGS. 5 to 7, the first source driver S-IC[1] may include the first receiving block groups RXG1, a first clock data recovery block group CDRG1, a first latch block group 310, a second latch block group 320, a gamma tap block GAMMA TAP, a digital-to-analog converting block group 330, an output buffer block group 340, and/or a shift register 350.

The first receiving block group RXG1 may include the first to third receiving blocks RX1 to RX3. The first clock data recovery block group CDRG1 may include first to third clock data recovery blocks CDR1 to CDR3.

The first receiving block RX1 may receive the first output image data ODAT1 and may transmit the first output image data ODAT1 to the first clock data recovery block CDR1. The first clock data recovery block CDR1 may receive the first output image data ODAT1 and recover the first output image data ODAT1. The first clock data recovery block CDR1 may output a first recovery output image data RDAT1.

The second receiving block RX2 may receive the second output image data ODAT2 and may transmit the second output image data ODAT2 to the second clock data recovery block CDR2. The second clock data recovery block CDR2 may receive the second output image data ODAT2 and recover the second output image data ODAT2. The second clock data recovery block CDR2 may output a second recovery output image data RDAT2.

The third receiving block RX3 may receive the third output image data ODAT3 and may transmit the third output image data ODAT3 to the third clock data recovery block CDR3. The third clock data recovery block CDR3 may receive the third output image data ODAT3 and recover the third output image data ODAT3. The third clock data recovery block CDR3 may output a third recovery output image data RDAT3.

The first clock data recovery block group CDRG1 may output a recovery clock signal RCLK to the shift register 350.

The shift register 350 may generate sampling signals SAMS based on the recovery clock signal RCLK. The shift register 350 may output the sampling signals SAMS to the first latch block group 310. In some example embodiments, the shift register 350 may include flip-flop circuits. The flip-flop circuits may perform a shifting operation in response to the recovery clock signal RCLK to generate the sampling signals SAMS.

The first latch block group 310 may include sampling latch blocks. The first latch block group 310 may include 1st to 1500th sampling latch blocks LAT1[1] to LAT1[1500].

The second latch block group 320 may include holding latch blocks. The second latch block group 320 may include 1st to 1500th holding latch blocks LAT2[1] to LAT2[1500].

The first to third clock data recovery blocks CDR1 to CDR3 may be connected to the sampling latch blocks. For example, the first clock data recovery block CDR1 may be connected to the 1st to 500th sampling latch blocks LAT1[1] to LAT1[500]. For example, the second clock data recovery block CDR2 may be connected to the 501st to 1000th sampling latch blocks LAT1[501] to LAT1[1000]. For example, the third clock data recovery block CDR3 may be connected to the 1001st to 1500th sampling latch blocks LAT1[1001] to LAT1[1500].

The first clock data recovery block CDR1 may transmit the first recovery output image data RDAT1 to the 1st to 500th sampling latch blocks LAT1[1] to LAT1[500]. The second clock data recovery block CDR2 may transmit the second recovery output image data RDAT2 to the 501st to 1000th sampling latch blocks LAT1[501] to LAT1[1000]. The third clock data recovery block CDR3 may transmit the third recovery output image data RDAT3 to the 1001st to 1500th sampling latch blocks LAT1[1001] to LAT1[1500].

The first latch block group 310 and the second latch block group 320 may sequentially store the first to third recovery output image data RDAT1 to RDAT3 based on the sampling signals SAMS. For example, the 1st to 500th sampling latch blocks LAT1[1] to LAT1[500] and the 1st to 500th holding latch blocks LAT2[1] to LAT2[500] may sequentially store the first recovery output image data RDAT1 based on the sampling signals SAMS. The 501st to 1000th sampling latch blocks LAT1[501] to LAT1[1000] and the 501st to 1000th holding latch blocks LAT2[501] to LAT2[1000] may sequentially store the second recovery output image data RDAT2 based on the sampling signals SAMS. The 1001st to 1500th sampling latch blocks LAT1[1001] to LAT1[1500] and the 1001st to 1500th holding latch blocks LAT2[1001] to LAT2[1500] may sequentially store the third recovery output image data RDAT3 based on the sampling signals SAMS.

The second latch block group 320 may output the first to third recovery output image data RDAT1 to RDAT3 for one pixel row to the digital-to-analog converting block group 330 based on a load signal Load.

Gamma tap block GAMMA TAP may generate grayscale voltages GV corresponding to each of grayscales. For example, the gamma tap block GAMMA TAP may generate 256 grayscale voltages GV corresponding to 0-grayscale to 255-grayscale, but the gamma tap block GAMMA TAP is not limited thereto.

The digital-analog converting block group 330 may include digital-analog converting blocks. The digital-analog converting block group 330 may include 1st to 1500th digital-analog converting blocks DAC[1] to DAC[1500].

The digital-analog converting block group 330 may receive the first to third recovery output image data RDAT1 to RDAT3 for the one pixel row from the second latch block group 320, may receive the grayscale voltages GV from the gamma tap block GAMMA TAP, and may convert the first to third recovery output image data RDAT1 to RDAT3 into the data voltages DV based on the grayscale voltages GV. For example, the first digital-analog converting block DAC[1] may receive the first recovery output image data RDAT1 and/or the grayscale voltages GV. The first digital-analog converting block DAC[1] may generate a first data voltage based on the first recovery output image data RDAT1 and/or the grayscale voltages GV. The first digital-analog converting block DAC[1] may output the first data voltage to the output buffer block group 340. For example, the 501st digital-analog converting block DAC[501] may receive the second recovery output image data RDAT2 and/or the grayscale voltages GV. The 501st digital-analog converting block DAC[501] may generate a 501st data voltage based on the second recovery output image data RDAT2 and/or the grayscale voltages GV. The 501st digital-analog converting block DAC[501] may output the 501st data voltage to the output buffer block group 340. For example, the 1001st digital-analog converting block DAC[1001] may receive the third recovery output image data RDAT3 and/or the grayscale voltages GV. The 1001st digital-analog converting block DAC[1001] may generate a 1001st data voltage based on the third recovery output image data RDAT3 and/or the grayscale voltages GV. The 1001st digital-analog converting block DAC[1001] may output the 1001st data voltage to the output buffer block group 340.

The output buffer block group 340 may include output buffer blocks. The output buffer block group 340 may include 1st to 1500th output buffer blocks OB[1] to OB[1500].

The 1st to 1500th output buffer blocks OB[1] to OB[1500] may connected to the data lines through channels Ch. For example, the first display region DP[1] may include 1st to 1500th data lines DL[1] to DL[1500]. For example, an output terminal of the first output buffer block OB[1] may be connected to the first channel Ch[1] and the first channel Ch[1] may be connected to the first data line DL[1]. An output terminal of the second output buffer block OB[2] may be connected to the second channel Ch[2] and the second channel Ch[2] may be connected to the second data line DL[2]. An output terminal of the third output buffer block OB[3] may be connected to the third channel Ch[3] and the third channel Ch[3] may be connected to the third data line DL[3]. For example, an output terminal of the 1500th output buffer block OB[1500] may be connected to the 1500th channel Ch[1500] and the 1500th channel Ch[1500] may be connected to the 1500th data line DL[1500].

The output buffer block group 340 may output the data voltages DV to the data lines included in the display panel 100. For example, the first output buffer block OB[1] may output the first data voltage to the first data line DL[1]. The second output buffer block OB[2] may output the second data voltage to the second data line DL[2]. The third output buffer block OB[3] may output the third data voltage to the third data line DL[3]. For example, the 1500th output buffer block OB[1500] may output the 1500th data voltage to the 1500th data line DL[1500].

The data driver 300 may include analog blocks. Each, or one or more, of the analog blocks may include one of the digital-analog converting blocks DAC and/or one of the output buffer blocks OB. For example, a first analog block may include the first digital-analog converting block DAC[1] and/or the first output buffer block OB[1]. According to some example embodiments, a second analog block may include the second digital-analog converting block DAC[2] and/or the second output buffer block OB[2]. In this way, a 1500th analog block may include the 1500th digital-analog converting block DAC[1500] and/or the 1500th output buffer block OB[1500]. The analog blocks may be individually turned on or off. For example, when the display device 1 performs the low power mode operation for the first sub-display region SDP[1] which is the same data region and/or performs the normal mode operation for the second to twelfth sub-display regions SDP[2] to SDP[12], the 1st to 500th analog blocks corresponding to the first sub-display region may be turned off and the 501st to 1500th analog blocks corresponding to the second to twelfth sub-display regions SDP[2] to SDP[12] may be turned on.

As illustrated in FIG. 6, the first display region DP[1] may be divided into the first to third sub-display regions SDP[1] to SDP[3]. The first sub-display region SDP[1] may include the 1st to 500th data lines DL[1] to DL[500]. The first receiving block RX1 may transmit the first recovery output image data RDAT1 to the first latch block group 310 for the first sub-display region SDP[1]. The second sub-display region SDP[2] may include the 501st to 1000th data lines DL[501] to DL[1000]. The second receiving block RX2 may transmit the second recovery output image data RDAT2 to the first latch block group 310 for the second sub-display region SDP[2]. The third sub-display region SDP[3] may include the 1001st to 1500th data lines DL[1001] to DL[1500]. The third receiving block RX3 may transmit the third recovery output image data RDAT3 to the first latch block group 310 for the third sub-display region SDP[3].

The driving controller 200 may determine the same data region, in which the output image is the same in the previous frame FP1 and the current frame FP2, among the first to third sub-display regions SDP[1] to SDP[3].

In some example embodiments, in the previous frame FP1, the first sub-display region SDP[1] may output a first image A, the second sub-display region SDP[2] may output a second image B, and/or the third sub-display region SDP[3] may output a third image C. In the current frame FP2, the first sub-display region SDP[1] may output the first image A, the second sub-display region SDP[2] may output a fourth image D, and/or the third sub-display region SDP[3] may output a fifth image E. The first sub-display region SDP[1] may be determined to output the same image in the previous frame FP1 and the current frame FP2. According to some example embodiments, the first output image data ODAT1 of the previous frame FP1 may be identical to the first output image data ODAT1 of the current frame FP2. For example, the first sub-display region SDP[1] may be the same data region and the driving controller 200 may determine the first sub-display region SDP[1] as the same data region.

The display device 1 may perform the low power mode operation for the first sub-display region SDP[1] and may perform the normal mode operation for the second and third sub-display regions SDP[2] and SDP[3]. The first transmitting block TX1, which transmits the first output image data ODAT1 from the driving controller 200 to the data driver 300, and/or the first receiving block RX1, which receives the first output image data ODAT1 transmitted by the first transmitting block TX1, may be turned off. According to some example embodiments, the first output image data ODAT1 may not be transmitted to the data driver 300 in the current frame FP2. As the first output image data ODAT1 is not transmitted to the data driver 300, the driving controller 200 and the data driver 300 may not consume the power. For example, the power consumption of the display device 1 including the driving controller 200 and the data driver 300 may be reduced.

As illustrated in FIG. 7, the previous frame FP1 may include a first active period AP1 and/or a first blank period BP1. The current frame FP2 may include a second active period and/or a second blank period BP2.

The driving controller 200 may determine the same data region, in which the output image is the same in the previous frame FP1 and the current frame FP2, in the first blank period BP1. According to some example embodiments, the driving controller 200 may determine the same data region, in which the output image is the same in the previous frame FP1 and the current frame FP2, in the second blank period BP2.

In the first active period AP1 and the second active period AP2, the driving controller 200 may transmit or not transmit the output image data ODAT to the data driver 300 according to the determination of the same data region.

The driving controller 200 may transmit the first to third protocol signals FCD1 to FCD3 of the previous frame FP1 to the data driver 300 through the first to third data transmitting lines DTL1 to DTL3 in the first blank period BP1. In some example embodiments, the driving controller 200 may transmit the first to third protocol signals FCD1 to FCD3 of the current frame FP2 to the data driver 300 through the first to third data transmitting lines DTL1 to DTL3 in the second blank period BP2.

The protocol signal FCD may include a low power mode entrance signal SDMB, which determines (e.g., indicates) whether the display device 1 enters the low power mode for the sub-display region SDP, and/or a low power mode termination signals SDMBO, which determines (e.g., indicates) whether the display device 1 terminates the low power mode for the sub-display region SDP.

For example, the first protocol signal FCD1 of the first blank period BP1 may include a first low power mode entrance signal SDMB1, which determines whether the display device 1 enters the low power mode for the first sub-display region SDP[1] in the current frame FP2, and/or a first low power mode termination signals SDMBO1, which determines whether the display device 1 terminates the low power mode for the first sub-display region SDP[1] in the current frame FP2. The second protocol signal FCD2 of the first blank period BP1 may include a second low power mode entrance signal SDMB2, which determines whether the display device 1 enters the low power mode for the second sub-display region SDP[2] in the current frame FP2, and/or a second low power mode termination signals SDMBO2, which determines whether the display device 1 terminates the low power mode for the second sub-display region SDP[2] in the current frame FP2. The third protocol signal FCD3 of the first blank period BP1 may include a third low power mode entrance signal SDMB3, which determines whether the display device 1 enters the low power mode for the third sub-display region SDP[3] in the current frame FP2, and/or a third low power mode termination signals SDMBO3, which determines whether the display device 1 terminates the low power mode for the third sub-display region SDP[3] in the current frame FP2.

The first protocol signal FCD1 of the second blank period BP2 may include a first low power mode entrance signal SDMB1, which determines whether the display device 1 enters the low power mode for the first sub-display region SDP[1] in a next frame, and/or a first low power mode termination signals SDMBO1, which determines whether the display device 1 terminates the low power mode for the first sub-display region SDP[1] in the next frame. The second protocol signal FCD2 of the second blank period BP2 may include a second low power mode entrance signal SDMB2, which determines whether the display device 1 enters the low power mode for the second sub-display region SDP[2] in the next frame, and/or a second low power mode termination signals SDMBO2, which determines whether the display device 1 terminates the low power mode for the second sub-display region SDP[2] in the next frame. The third protocol signal FCD3 of the second blank period BP2 may include a third low power mode entrance signal SDMB3, which determines whether the display device 1 enters the low power mode for the third sub-display region SDP[3] in the next frame, and/or a third low power mode termination signals SDMBO3, which determines whether the display device 1 terminates the low power mode for the third sub-display region SDP[3] in the next frame.

The display device 1 may perform the low power mode operation for the sub-display region SDP in response to the low power mode entrance signal SDMB having a first level (e.g. a high level). The display device 1 may perform the normal mode operation for the sub-display region SDP in response to the low power mode entrance signal SDMB having a second level (e.g. a low level).

When the display device 1 performs the low power mode operation for the sub-display region SDP, the transmitting block TX and/or the receiving block RX corresponding to the sub-display region SDP may be turned off. For example, the output image data ODAT may not be transmitted to the data driver 300. For example, the driving controller 200 and the data driver 300 may not consume the power. For example, the power consumption of the display device 1 including the driving controller 200 and the data driver 300 may be reduced.

When the display device 1 performs the normal mode operation for the sub-display region SDP, the transmitting block TX and/or the receiving block RX corresponding to the sub-display region SDP may be turned on. For example, the output image data ODAT may be transmitted to the data driver 300.

The display device 1 may terminate the low power mode operation for the sub-display region SDP in response to the low power mode termination signal SDMBO having the first level (e.g. the high level). When the low power mode termination signal SDMBO has the second level (e.g. the low level), the display device 1 may select a driving mode according to the low power mode entrance signal SDMB.

For example, in the first blank period BP1, the driving controller 200 may determine that the output image for the first sub-display region SDP[1] of the previous frame FP1 is identical to the output image for the first sub-display region SDP[1] of the current frame FP2. For example, the first output image data ODAT1 for the first sub-display region SDP[1] of the previous frame FP1 may be identical to the first output image data ODAT1 for the first sub-display region SDP[1] of the current frame FP2. The first sub-display region SDP[1] may be the same data region and the driving controller 200 may determine the first sub-display region SDP[1] as the same data region. The first low power mode entrance signal SDMB1 included in the first protocol signal FCD1 of the first blank period BP1 may have the first level SDMB1(H) and the first low power mode termination signal SDMBO1 included in the first protocol signal FCD1 of the first blank period BP1 may have the second level SDMBO1(L). According to some example embodiments, the display device 1 may perform the low power mode operation for the first sub-display region SDP[1] in the current frame FP2. The first transmitting block TX1, which transmits the first output image data ODAT1 from the driving controller 200 to the data driver 300, and/or the first receiving block RX1, which receives the first output image data ODAT1 transmitted by the first transmitting block TX1, may be turned off. The first output image data ODAT1 may not be transmitted to the data driver 300 in the second active frame AP2.

According to some example embodiments, the display device 1 may perform the low power mode operation in the second active period AP2 and the driving controller 200 may determine that the output image for the first sub-display region SDP[1] of the current frame FP2 and the output image for the first sub-display region SDP[1] of the next frame are different in the second blank period BP2. The first low power mode entrance signal SDMB1 included in the protocol signal FCD1 of the second blank period BP2 may have the second level SDMB1(L) and the first low power mode termination signal SDMBO1 included in the protocol signal FCD1 of the second blank period BP2 may have the first level SDMBO1(H). According to some example embodiments, the display device 1 may terminate the low power mode operation for the first sub-display region SDP[1] in the next frame and may perform the normal mode operation for the first sub-display region SDP[1] in the next frame.

According to some example embodiments, in the first blank period BP1, the driving controller 200 may determine that the output image for the second sub-display region SDP[2] of the previous frame FP1 and the output image for the second sub-display region SDP[2] of the current frame FP2 are different. For example, the driving controller 200 may determine that the second output image data ODAT2 of the previous frame FP1 and the second output image data ODAT2′ of the current frame FP2 are different. The second low power mode entrance signal SDMB2 included in the second protocol signal FCD2 of the first blank period BP1 may have the second level SDMB2(L) and/or the second low power mode termination signal SDMBO2 included in the second protocol signal FCD2 of the first blank period BP1 may have the second level SDMBO2(L). the display device 1 may perform the normal mode operation for the second sub-display region SDP[2] in the current frame FP2. The second transmitting block TX2, which transmits the second output image data ODAT2′ from the driving controller 200 to the data driver 300, and/or the second receiving block RX2, which receives the second output image data ODAT2′ transmitted by the second transmitting block TX2, may be turned on. The second output image data ODAT2′ may be transmitted to the data driver 300 in the second active period AP2.

According to some example embodiments, in the first blank period BP1, the driving controller 200 may determine that the output image for the third sub-display region SDP[3] of the previous frame FP1 and the output image for the third sub-display region SDP[3] of the current frame FP2 are different. For example, the driving controller 200 may determine that the third output image data ODAT3 of the previous frame FP1 and the third output image data ODAT3′ of the current frame FP2 are different. The third low power mode entrance signal SDMB3 included in the third protocol signal FCD3 of the first blank period BP1 may have the second level SDMB3(L) and the third low power mode termination signal SDMBO3 included in the third protocol signal FCD3 of the first blank period BP1 may have the second level SDMBO3(L). The display device 1 may perform the normal mode operation for the third sub-display region SDP[3] in the current frame FP2. The third transmitting block TX3, which transmits the third output image data ODAT3′ from the driving controller 200 to the data driver 300, and the third receiving block RX3, which receives the second output image data ODAT3′ transmitted by the third transmitting block TX3, may be turned on. The third output image data ODAT3′ may be transmitted to the data driver 300 in the second active period AP2.

The protocol signal FCD is described as including the low power mode entrance signal SDMB and the low power mode termination signal SDMBO in FIG. 7, but the low power mode entrance signal SDMB and the low power mode termination signal SDMBO may be one low power mode signal. For example, when the low power mode signal included in the first protocol signal FCD1 of the first blank period BP1 has the first level (e.g. the high level), the display device 1 may perform the low power mode operation in the current frame FP2. When the low power mode signal included in the first protocol signal FCD1 of the first blank period BP1 has the second level (e.g. the low level), the display device 1 may perform the normal mode operation in the current frame FP2.

The forward signal group SFCSG may include first to third forward signals SFCS1 to SFCS3. The data driver 300 may receive the first to third forward signals SFCS1 to SFCS3.

In the first blank period BP1, the driving controller 200 may transmit first to third clock training patterns CTP1 to CTP3 of the previous frame FP1 to the data driver 300 through the first to third data transmitting lines DTL1 to DTL3 based on the first to third forward signals SFCS1 to SFCS3. For example, the driving controller 200 may transmit the first clock training pattern CTP1 of the previous frame FP1 to the data driver 300 in response to the first forward signal SFCS1 having the low level. In some example embodiments, the driving controller 200 may transmit the second clock training pattern CTP2 of the previous frame FP1 to the data driver 300 in response to the second forward signal SFCS2 having the low level. In some example embodiments, the driving controller 200 may transmit the third clock training pattern CTP3 of the previous frame FP1 to the data driver 300 in response to the third forward signal SFCS3 having the low level.

In the second blank period BP2, the driving controller 200 may transmit the first to third clock training patterns CTP1 to CTP3 of the current frame FP2 to the data driver 300 through the first to third data transmitting lines DTL1 to DTL3 based on the first to third forward signals SFCS1 to SFCS3. For example, the driving controller 200 may transmit the first clock training pattern CTP1 of the current frame FP2 to the data driver 300 in response to the first forward signal SFCS1 having the low level. In some example embodiments, the driving controller 200 may transmit the second clock training pattern CTP2 of the current frame FP2 to the data driver 300 in response to the second forward signal SFCS2 having the low level. In some example embodiments, the driving controller 200 may transmit the third clock training pattern CTP3 of the current frame FP1 to the data driver 300 in response to the third forward signal SFCS3 having the low level.

The first clock data recovery block group CDRG1 may recover a frequency and/or a phase of a recovery clock signal RCLK based on the first to third clock training patterns CTP1 to CTP3.

When the driving controller determines that the output image of the previous frame FP1 is identical to the output image of the current frame FP2 in the first blank period BP1, the display device 1 may perform the low power mode operation for the first sub-display region SDP[1] in response to the first protocol signal FCD1 including the first low power mode entrance signal SDMB1 having the first level and the first low power mode termination signal SDMBO1 having the second level in the second active period AP2.

The first transmitting block TX1, which transmits the first output image data ODAT1 from the driving controller 200 to the data driver 300, and/or the first receiving block RX1, which receives the first output image data ODATA1 transmitted by the first transmitting block TX1 may be turned off. According to some example embodiments, the first output image data ODAT1 may not be transmitted to the data driver 300. According to some example embodiments, the driving controller 200 and the data driver 300 may not consume the power. That is, the power consumption of the display device 1 including the driving controller 200 and the data driver 300 may be reduced.

In some example embodiments, the first analog block corresponding to the first sub-display region SDP[1] may be turned off. For example, the first analog block may not generate the data voltages DV for the first sub-display region SDP[1]. As the data voltages DV for the first sub-display region SDP[1] are not generated, the data driver 300 may not consume the power. That is, the power consumption of the display device 1 including the data driver 300 may be reduced.

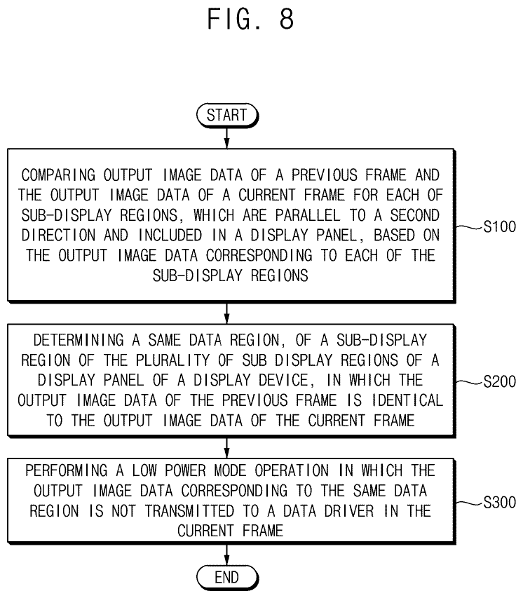

FIG. 8 is a flow chart illustrating a method of operating the display device 1 of FIG. 1.

Referring to FIG. 8, the method of operating the display device 1, in which the gate line extends in the first direction D1 and the data line extends in the second direction D2 intersecting with the first direction D1, may include comparing output image data ODAT of the previous frame FP1 and the output image data ODAT of the current frame FP2 for each, or one or more, of the sub-display regions SDP, which are parallel to the second direction D2 and included in the display panel 100, based on the output image data ODAT corresponding to each, or one or more, of the sub-display regions SDP S100, determining the same data region, of the sub-display region of the plurality of sub-display regions SDP of the display panel 100 of the display device 1, in which the output image data ODAT of the previous frame FP1 is identical to the output image data ODAT of the current frame FP2 S200, and performing the low power mode operation in which the output image data ODAT corresponding to the same data region is not transmitted to the data driver 300 in the current frame FP2 S300.

In some example embodiments, in the comparing output image data ODAT of the previous frame FP1 and the output image data ODAT of the current frame FP2 for each, or one or more, of the sub-display regions SDP, which are parallel to the second direction D2 and included in the display panel 100, based on the output image data ODAT corresponding to each, or one or more, of the sub-display regions SDP S100, the driving controller 200 may determine whether the first to twelfth output image data ODAT1 to ODAT12 corresponding to each, or one or more, of the first to twelfth sub-display regions SDP[1] to SDP[2] of the previous frame FP1 and the first to twelfth output image data ODAT1 to ODAT12 corresponding to each, or one or more, of the first to twelfth sub-display regions SDP[1] to SDP[2] of the current frame FP2 are the same.

According to some example embodiments, in the determining the same data region, of the sub-display region of the plurality of sub-display regions SDP of the display panel 100 of the display device 1, in which the output image data ODAT of the previous frame FP1 is identical to the output image data ODAT of the current frame FP2 S200, the driving controller 200 may determine the same data region in which the output image data ODAT of the previous frame FP2 is identical to the output image data ODAT of the current frame FP2 among the first to twelfth sub-display regions SDP[1] to SDP[12]. For example, as described in FIG. 6, the first sub-display region SDP[1] may be the same data region and the driving controller 200 may determine the first sub-display regions SDP[1] as the same data region.

According to some example embodiments, in the performing the low power mode operation in which the output image data ODAT corresponding to the same data region is not transmitted to the data driver 300 in the current frame FP2 S300, the driving controller 200 may determine that the display device 1 performs the low power mode operation for the same data region. In some example embodiments, the driving controller 200 may determine that the display device 1 performs the normal mode operation for the second to twelfth sub-display regions SDP[2] to SDP[12]. For example, the driving controller 200 may determine that the display device 1 performs the low power mode operation for the first sub-display region SDP[1], which is the same data region. The first transmitting block TX1 and/or the first receiving block RX1 corresponding to the first sub-display region SDP[1] may be turned off in the current frame FP2.

The first output image data ODAT1 may not be transmitted to the data driver 300 in the current frame FP2. As the first output image data ODAT1 is not transmitted to the data driver 300, the driving controller 200 and the data driver 300 may not consume the power. For example, the power consumption of the display device 1 including the driving controller 200 and the data driver 300 may be reduced.

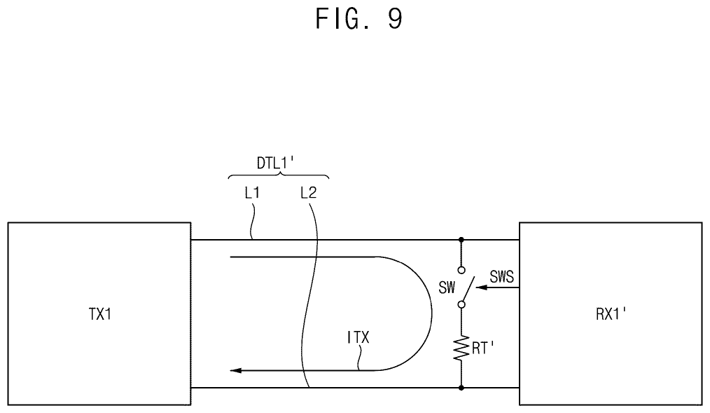

FIG. 9 is a diagram illustrating some example embodiments of a transmitting block of a transmitting block group included in the transmitter group of FIG. 3 and a receiving block of a receiving block group included in the receiver group of FIG. 3.

Referring to FIG. 9, the transmitting block TX and the receiving block RX may be connected through the data transmitting line DTL. The data transmitting line DTL further include a switch SW. The transmitting block TX and the receiving block RX of FIG. 9 is substantially the same as the transmitting block TX and the receiving block RX of FIG. 4 except that a first receiving block RX1′ outputs a switching signal SWS. Thus, the same reference numerals will be used to refer to the same or like parts as those described in the previous embodiment of FIG. 4 and any repetitive explanation concerning the above elements will be omitted.

The first transmitting block TX1 and the receiving block RX1′ may be connected through the first data transmitting line DTL1'. The first data transmitting line DTL1′ may include the first line L1, the second line L2, the switch SW, and/or the load resistor RT'. A first electrode of the switch SW may be connected to the first line L1 and a second electrode of the switch SW may be connected to the first electrode of the load resistor RT′. The first electrode of the load resistor RT′ may be connected to the second electrode of the switch SW and the second electrode of the load resistor RT′ may be connected to the second line L2.

The first receiving block RX1′ may transmit the switching signal SWS to the switch SW. The switch SW may be turned on or off in response to the switching signal SWS.

When the switch SW receives the switching signal SWS having a turned on level, the switch SW may be turned on. When the switch SW is turned on, a transmitting current IDX may flow through the load resistor RT′. For example, when the switch SW is turned on, the transmitting current IDX corresponding to the first output image data ODAT1 may flow through the load resistor RT′ when the first transmitting block TX1 transmits the first output image data ODAT1 to the first receiving block RX1′. The first output image data ODAT1 may be transmitted to the first receiving block RX1′.

When the switch SW receives the switching signal SWS having a turned off level, the switch SW may be turned off. When the switch SW is turned off, the transmitting current IDX may not flow through the load resistor RT'. For example, when the switch SW is turned off, the transmitting current IDX corresponding to the first output image data ODAT1 may not flow through the load resistor RT′ when the first transmitting block TX1 transmits the first output image data ODAT1 to the first receiving block RX1′.

In some example embodiments, the output image for the first sub-display region SDP[1] of the previous frame FP1 may be identical to the output image for the first sub-display region SDP[1] of the current frame FP2. For example, the first output image data ODAT1 for the first sub-display region SDP[1] of the previous frame FP1 may be identical to the first output image data ODAT1 for the first sub-display region SDP[1] of the current frame FP2. The first sub-display region SDP[1] may be the same data region and the driving controller 200 may determine the first sub-display region SDP[1] as the same data region. The first receiving block RX1′ may output the switching signal SWS having the turned off level to the switch SW. The switch SW may be turned off in response to the switching signal SWS having the turned off level. When the switch SW is turned off, the transmitting current IDX corresponding to the first output image data ODAT1 may not flow through the load resistor RT′. For example, the first output image data ODAT1 may not be transmitted to the data driver 300. As the first output image data ODAT1 is not transmitted to the data driver 300, the driving controller 200 and the data driver 300 may not consume the power. For example, the power consumption of the display device 1 including the driving controller 200 and the data driver 300 may be reduced.

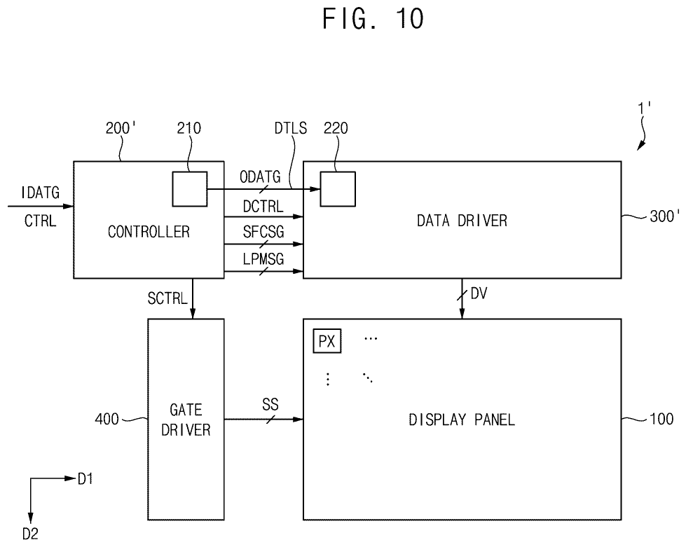

FIG. 10 is a block diagram illustrating a display device 1′ according to some example embodiments.

Referring to FIG. 10, the display device 1′ may include the display panel 100 including the pixels PX, the gate driver 400 which provides the gate signals SS to the pixels PX, a data driver 300′ which provides the data voltages DV to the pixels PX, and/or a driving controller 200′ which controls the gate driver 400 and the data driver 300′. The display device 1′ is substantially the same as the display device 1 of FIG. 1 except that the driving controller 200′ transmits a low power signal group LPMSG to the data driver 300′ through a low power signal transmitting line group which is distinguished from the data transmitting line group DTLS. Thus, the same reference numerals will be used to refer to the same or like parts as those described in the previous embodiment of FIG. 1 and any repetitive explanation concerning the above elements will be omitted.

The driving controller 200′ may transmit the low power signal group LPMSG to the data driver 300′ through the low power signal transmitting line group which is distinguished from the data transmitting line group DTLS. The display device 1′ may perform the low power mode operation or the normal mode operation based on the low power signal group LPMSG.

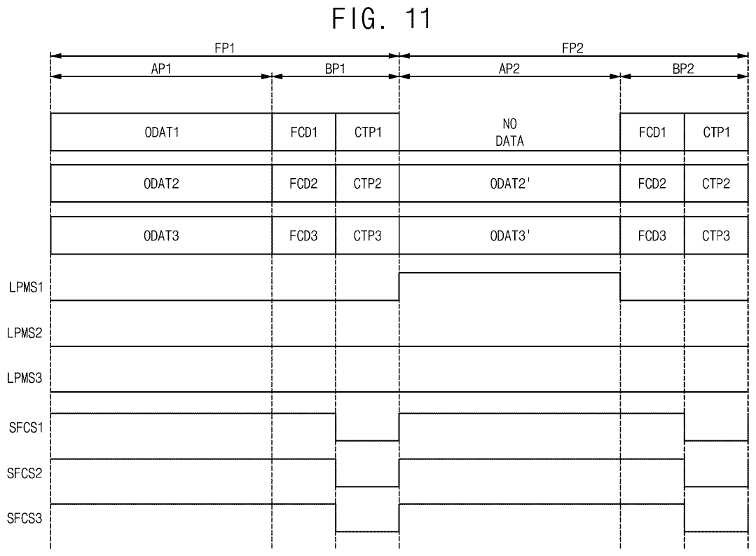

FIG. 11 is a timing diagram illustrating some example embodiments of an operation for the same data region of the display panel 100 performed by the data driver 300′ included in the display device 1′ of FIG. 10.

Referring to FIG. 11, the previous frame FP1 may include the first active period AP1 and/or the first blank period BP1. The current frame FP2 may include the second active period AP2 and/or the second blank period BP2. The timing diagram of the FIG. 11 is substantially the same as the timing diagram of FIG. 7 except that the protocol signal FCD does not include the low power mode entrance signal SDMB and the low power mode termination signal SDMBO and the low power signal group LPMSG is transmitted to the data driver 300′. Thus, the same reference numerals will be used to refer to the same or like parts as those described in the previous embodiment of FIG. 7 and any repetitive explanation concerning the above elements will be omitted.

The low power signal group LPMSG may include first to third low power signals LPMS1 to LPMS3. The display device 1′ may perform the low power mode operation or the normal mode operation for the first sub-display region SDP[1] based on the first low power signal LPMS1. In some example embodiments, the display device 1′ may perform the low power mode operation or the normal mode operation for the second sub-display region SDP[2] based on the second low power signal LPMS2. In some example embodiments, the display device 1′ may perform the low power mode operation or the normal mode operation for the third sub-display region SDP[3] based on the third low power signal LPMS3.

When the low power signals LPMS has the first level (e.g. the high level), the display device 1′ may perform the low power mode operation for the sub-display region SDP. For example, the output image data ODAT may not be transmitted to the data driver 300′ in the active period AP. When the low power signal LPMS has the second level (e.g. the low level), the display device 1′ may perform the normal mode operation for the sub-display region SDP. For example, the output image data ODAT may be transmitted to the data driver 300′ in the active period AP.

In some example embodiments, the first to third low power signals LPMS1 to LPMS3 may have the second levels in the previous frame FP1.

In the first blank period BP1, the driving controller 200′ may determine that the output image for the first sub-display region SDP[1] of the previous frame FP1 is identical to the output image for the first sub-display region SDP[1] of the current frame FP2. For example, the first output image data ODAT1 for the sub-display region SDP[1] of the previous frame FP1 may be identical to the first output image data ODAT1 for the sub-display region SDP[1] of the current frame FP2. The first sub-display region SDP[1] may be the same data region. The driving controller 200′ may determine the first sub-display region SDP[1] as the same data region. The first low power signal LPMS1 may have the first level in the second active period AP2. The display device 1′ may perform the low power mode operation for the first sub-display region SDP[1] in the current frame FP2. The first transmitting block TX1, which transmits the first output image data ODAT1 from the driving controller 200′ to the data driver 300′, and/or the first receiving block RX1, which is receives the first output image data ODAT1 transmitted by the first transmitting block TX1, may be turned off. The first output image data ODAT1 may not be transmitted to the data driver 300′ in the second active period AP2.

In some example embodiments, in the first blank period BP1, the driving controller 200′ may determine that the output image for the second sub-display region SDP[2] of the previous frame FP1 and the output image for the second sub-display region SDP[2] of the current frame FP2 are different. For example, the driving controller 200′ may determine that the second output image data ODAT2 of the previous frame FP1 and the second output image data ODAT2 of the current frame FP2 are different. The second low power signal LPMS2 may maintain the second level. The display device 1′ may perform the normal mode operation for the second sub-display region SDP[2] in the current frame FP2. The second transmitting block TX2, which transmits the second output image data ODAT2 from the driving controller 200′ to the data driver 300′, and the second receiving block RX2, which receives the second output image data ODAT2 transmitted by the second transmitting block TX2, may be turned on. The second output image data ODAT2 may be transmitted to the data driver 300′ in the second active period AP2.

In some example embodiments, in the first blank period BP1, the driving controller 200′ may determine that the output image for the third sub-display region SDP[3] of the previous frame FP1 and the output image for the third sub-display region SDP[3] of the current frame FP2 are different. For example, the driving controller 200′ may determine that the third output image data ODAT3 of the previous frame FP1 and the third output image data ODAT3 of the current frame FP2 are different. The third low power signal LPMS3 may maintain the second level. The display device 1′ may perform the normal mode operation for the third sub-display region SDP[3] in the current frame FP2. The third transmitting block TX3, which transmits the third output image data ODAT3 from the driving controller 200′ to the data driver 300′, and the third receiving block RX3, which receives the third output image data ODAT3 transmitted by the third transmitting block TX3, may be turned on. The third output image data ODAT3 may be transmitted to the data driver 300′ in the second active period AP2.

The first sub-display region SDP[1] may be the same data region and the display device 1′ may perform the low power mode operation for the first sub-display region SPD[1]. The driving controller 200′ the first transmitting block TX1, which transmits the first output image data ODAT1 from the driving controller 200′ to the data driver 300′, and/or the first receiving block RX1, which receives the first output image data ODAT1 transmitted by the first transmitting block TX1, may be turned off. The first output image data ODAT1 may not be transmitted to the data driver 300′ in the second active period AP2. As the first output image data ODAT1 is not transmitted to the data driver 300', the driving controller 200′ and the data driver 300′ may not consume power. For example, power consumption of the display device 1′ including the driving controller 200′ and the data driver 300′ may be reduced.

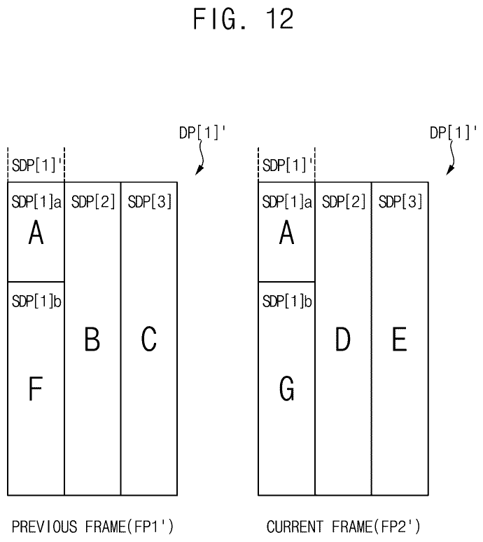

FIG. 12 is a diagram illustrating determining the same data region of the display panel 100 included in the display device 1 of FIG. 1.

Referring to FIG. 12, the first display region DP[1]′ may be divided into first to third sub-display regions SDP[1]′ to SDP[3]. The first display region DP[1]′ of FIG. 12 is substantially the same as the first display region DP[1] of FIG. 6 except for the first sub-display region SDP[1]′. Thus, the same reference numerals will be used to refer to the same or like parts as those described in the example embodiments of FIG. 6 and any repetitive explanation concerning the above elements will be omitted.

The driving controller 200 may determine the same data region in which the output image of the previous frame FP1′ and the output image of the current frame FP1′ is the same among the first to third sub-display regions SDP[1]′ to SDP[3].

In some example embodiments, in the previous frame FP1′, a first region SDP[1]a of the first sub-display region SDP[1]′ may output the first image A, a second region SDP[1]b of the first sub-display region SDP[1]′ may output a sixth image F, the second sub-display region SDP[2] may output the second image B, and/or the third sub-display region SDP[3] may output the third image C. In the current frame FP2', the first region SDP[1]a of the first sub-display region SDP[1]′ may output the first image A, the second region SDP[1]b of the first sub-display region SDP[1]′ may output a seventh image G, the second sub-display region SDP[2] may output the fourth image D, and/or the third sub-display region SDP[3] may output the fifth image E. The driving controller 200 may determine that the first region SDP[1]a of the first sub-display region SDP[1]′ outputs the same image in the previous frame FP1′ and the current frame FP2′. Accordingly, the first output image data ODAT1 for the first region SDP[1]a of the first sub-display region SDP[1]′ of the previous frame FP1′ is identical to the first output image data ODAT1 for the first region SDP[1]a of the first sub-display region SDP[1]′ of the current frame FP2'. For example, the first region SDP[1]a of the first sub-display region SDP[1]′ may be the same data region and the driving controller 200 may determine the first region SDP[1]a of the first sub-display region SDP[1]′ as the same data region.

The first protocol signal FCD1 of the previous frame FP1′ may further include information for the same data region. For example, the first protocol signal FCD1 may further include a start bit signal for a first pixel row of the same data region and/or a termination bit signal for a last pixel row of the same data region.

In the second active period AP2 of the current frame FP2′, it is assumed that a period corresponding to the first region SDP[1]a of the first sub-display region SDP[1]′ is a first sub active period and a period corresponding to the second region SDP[1]b of the first sub-display region SDP[1]′ is a second active period. In the first sub active period, the display device 1 may perform the low power mode operation for the first region SDP[1]a of the first sub-display region SDP[1]′ based on the start bit signal and/or the termination bit signal. In the second sub active period, the display device 1 may perform the normal mode operation for the second region SDP[1]b of the first sub-display region SDP[1]′ based on the start bit signal and/or the termination bit signal.

In the first sub active period, the first transmitting block TX1, which transmits the first output image data ODAT1 from the driving controller 200 to the data driver 300, and/or the first receiving block RX1, which receives the first output image data ODAT transmitted by the first transmitting block TX1, may be turned off. In the second sub active period, the first transmitting block TX1 and the first receiving block RX1 may be turned on. The first output image data ODAT1 for the first region SDP[1]a of the first sub-display region SDP[1]′ may not be transmitted to the data driver 300 in the first sub active period. The first output image data ODAT1 for the second region SDP[1]b of the first sub-display region SDP[1]′ may be transmitted to the data driver 300 in the second sub active period.

As the first output image data ODAT1 for the first region SDP[1]a of the first sub-display region SDP[1]′ is not transmitted to the data driver 300 in the first sub active period, the driving controller 200 and the data driver 300 may not consume the power. For example, the power consumption of the display device 1 including the driving controller 200 and/or the data driver 300 may be reduced.

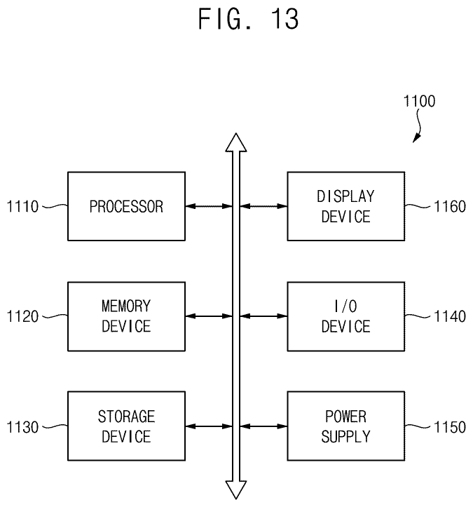

FIG. 13 is a block diagram illustrating an electronic device 1100 according to embodiments.

Referring to FIG. 13, the electronic device 1100 may include a processor 1110, a memory device 1120, a storage device 1130, an input/output (I/O) device 1140, a power supply 1150, and/or a display device 1160. The electronic device 1100 may further include a plurality of ports for communicating with a video card, a sound card, a memory card, a universal serial bus (USB) device, other electric devices, etc.

The processor 1110 may perform various computing functions and/or tasks. The processor 1110 may be a micro processor, a central processing unit (CPU), etc. The processor 1110 may be coupled to other components via an address bus, a control bus, a data bus, etc. Further, in some embodiments, the processor 1110 may be further coupled to an extended bus such as a peripheral component interconnection (PCI) bus.

In some example embodiments, the display device 1160 may be the display device 1 of the FIG. 1. The processor 1110 may generate the control signal CTRL and the input image data group IDATG and may output the control signal CTRL and/or the input image data group IDATG to the driving controller 200 included in the display device 1.

The memory device 1120 may store data for operations of the electronic device 1100. For example, the memory device 1120 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc., and/or at least one volatile memory device such as a dynamic random access memory (DRAM) device, a static random access memory (SRAM) device, a mobile dynamic random access memory (mobile DRAM) device, etc.

The storage device 1130 may be a solid state drive (SSD) device, a hard disk drive (HDD) device, a compact disk-read only memory (CD-ROM) device, etc. The I/O device 1140 may be an input device such as a keyboard, a keypad, a mouse, a touch screen, etc., and/or an output device such as a printer, a speaker, etc. The power supply 1150 may supply power for operations of the electronic device 1100. The display device 1160 may be coupled to other components via the buses or other communication links.

According to some example embodiments, the electronic device 1100 may be an electronic device including the display device 1160, such as a digital television, a three dimensional (3D) television, a personal computer (PC), a home appliance, a laptop computer, a cellular phone, a smart phone, a tablet computer, a wearable device, a personal digital assistant (PDA), a portable multimedia player (PMP), a digital camera, a music player, a portable game console, a navigation system, etc.

The display device 1160 may be the display device 1 of FIG. 1 and/or the display device 1′ of FIG. 9.

In some example embodiments, the output image for the first sub-display region SDP[1] of the previous frame FP1 may be identical to the output image for the first sub-display region SDP[1] of the current frame FP2. For example, the first output image data ODAT1 for the first sub-display region SDP[1] of the previous frame FP1 may be identical to the first output image data ODAT1 for the first sub-display region SDP[1] of the current frame FP2. The first sub-display region SDP[1] may be the same data region and the driving controller 200 may determine the first sub-display region SDP[1] as the same data region. The first transmitting block TX1, which transmits the first output image data ODAT1 from the driving controller 200 to the data driver 300, and/or the first receiving block RX1, which receives the first output image data ODAT1 transmitted by the first transmitting block TX1, may be turned off. The first output image data ODAT1 may not be transmitted to the data driver 300.

For example, the when the first output image data ODAT is the same in the previous frame FP1 and the current frame FP2, the display device 1 may perform the low power mode operation for the first sub-display region SDP[1] and may perform the normal mode operation for the second to twelfth sub-display regions SDP[2] to SDP[12]. The first output image data ODAT1 may not be transmitted to the data driver 300 in the current frame FP2. As the first output image data ODAT1 is not transmitted to the data driver 300, the driving controller 200 and the data driver 300 may not consume the power. For example, the power consumption of the display device 1 including the driving controller 200 and the data driver 300 may be reduced.

The inventive concepts may be applied to a display device and/or an electronic device including the display device. For example, the inventive concepts may be applied to a television (TV), a digital TV, a 3D TV, a mobile phone, a smart phone, a tablet computer, a laptop computer, a personal computer (PC), a household electronic device, a personal digital assistant (PDA), a portable multimedia player (PMP), a digital camera, a music player, a portable game console, a navigation device, etc.

One or more of the elements disclosed above may include or be implemented in one or more processing circuitries such as hardware including logic circuits; a hardware/software combination such as a processor executing software; or a combination thereof. For example, the processing circuitries more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The foregoing is illustrative of the inventive concepts and is not to be construed as limiting thereof. Although some example embodiments of the inventive concepts have been described, those skilled in the art will readily appreciate that many modifications are possible in the example embodiments without materially departing from the novel teachings and advantages of the inventive concepts. Accordingly, all such modifications are intended to be included within the scope of the inventive concepts as defined in the claims. In the claims, means-plus-function clauses are intended to cover the structures described herein as performing the recited function and not only structural equivalents but also equivalent structures. Therefore, it is to be understood that the foregoing is illustrative of the inventive concepts and is not to be construed as limited to the specific example embodiments disclosed, and that modifications to the disclosed example embodiments, as well as other example embodiments, are intended to be included within the scope of the appended claims. The inventive concepts are defined by the following claims, with equivalents of the claims to be included therein.

What is claimed is:

1. A display device comprising:
a display panel including pixels;
a gate driver configured to output a gate signal to the pixels through a gate line extending in a first direction;
a data driver configured to output a data voltage to the pixels through a data line extending in a second direction intersecting with the first direction; and
a driving controller configured to
control the gate driver and the data driver,
determine a same data region, of a sub-display region of a plurality of sub-display regions of the display panel parallel to the second direction, in which output image data of a previous frame is identical to output image data of a current frame, and
perform a low power mode operation which does not transmit the output image data corresponding the same data region to the data driver in the current frame.

2. The display device of claim 1, wherein the driving controller is further configured to perform the low power mode operation by turning off at least one component included in the data driver.

3. The display device of claim 2, wherein the data driver includes a plurality of receiving blocks, each receiving block of the plurality of receiving blocks corresponding to a respective sub-display region of the plurality of sub-display regions,
wherein each receiving block of the plurality of receiving blocks is configured to receive the output image data corresponding to the respective sub-display region, and
wherein the driving controller is configured to turn off a receiving block, of the plurality of receiving blocks, corresponding to the same data region in the current frame.

4. The display device of claim 1, wherein the driving controller is further configured to perform the low power mode operation by turning off at least one component included in the driving controller.

5. The display device of claim 4, wherein the driving controller includes a plurality of transmitting blocks, each transmitting block of the plurality of transmitting blocks corresponding to a respective sub-display region of the plurality of sub-display regions,
wherein each transmitting block of the plurality of transmitting blocks is configured to transmit the output image data corresponding to the respective sub-display region to the data driver, and
wherein the driving controller is configured to turn off a transmitting block, of the plurality of transmitting blocks, corresponding to the same data region in the current frame.

6. The display device of claim 1, wherein the driving controller is further configured to perform the low power mode operation by turning off at least one component included in the data driver and at least one component included in the driving controller.

7. The display device of claim 6, wherein the data driver includes a plurality of receiving blocks, each receiving block of the plurality of receiving blocks corresponding to a respective sub-display region of the plurality of sub-display regions,
wherein each receiving block of the plurality of receiving blocks is configured to receive the output image data corresponding to the respective sub-display region,
wherein the driving controller includes a plurality of transmitting blocks, each transmitting block of the plurality of transmitting blocks corresponding to a respective sub-display region of the plurality of sub-display regions,
wherein each transmitting block of the plurality of transmitting blocks is configured to transmit the output image data corresponding to the respective sub-display region to a respective receiving block of the plurality of receiving blocks, and
wherein the driving controller is configured to
turn off a receiving block, of the plurality of receiving blocks, corresponding to the same data region in the current frame, and
turn off a transmitting block, of the plurality of transmitting blocks, corresponding to the same data region in the current frame.

8. The display device of claim 1, wherein the driving controller is configured to transmit, in a blank period of the previous frame, a plurality of protocol signals to the data driver through a plurality of data transmitting lines configured to transmit the output image data in the blank period of the previous frame, each protocol signal of the plurality of protocol signals corresponding to a respective sub-display region of the plurality of sub-display regions, and
wherein each protocol signals of the plurality of protocol signals includes a low power mode entrance signal and a low power mode termination signal indicating whether to perform the low power mode operation for a respective sub-display region of the plurality of sub-display regions in the current frame.

9. The display device of claim 8, wherein the driving controller is configured to perform the low power mode operation for a first target sub-display region, of the plurality of sub-display regions, corresponding to the low power mode entrance signal having an activation level in the current frame.

10. The display device of claim 8, wherein the driving controller is configured to terminate the low power mode operation for a second target sub-display region, of the plurality of sub-display regions, corresponding to the low power mode termination signal having an activation level in the current frame.

11. The display device of claim 1, wherein the driving controller is configured to transmit, to the data driver through signal transmitting lines different from data transmitting lines for transmitting the output image data, a plurality of low power signals, each low power signal of the plurality of low power signals indicating whether to perform the low power mode operation for a respective sub-display region of the plurality of sub-display regions.

12. The display device of claim 11, wherein the driving controller is configured to
perform the low power mode operation for a first target sub-display region, of the plurality of sub-display regions, corresponding to a first low power signal of the plurality of low power signals in response to the first low power signal having an activation level, and
perform a normal mode operation in which the data driver receives the output image data for a second target sub-display region, of the plurality of sub-display regions, corresponding to a second low power signal of the plurality of low power signals in response to the second low power signal having a deactivation level.

13. A method of operating a display device in which a gate line extends in a first direction and a data line extends in a second direction intersecting with the first direction, the method comprising:
determining a same data region, of a sub-display region of a plurality of sub-display regions of a display panel of the display device, in which output image data of a previous frame is identical to output image data of a current frame; and
performing a low power mode operation in which the output image data corresponding to the same data region is not transmitted to a data driver in the current frame.

14. The method of claim 13, wherein the performing the low power mode operation includes turning off at least one component included in the data driver.

15. The method of claim 14, wherein the data driver includes a plurality of receiving blocks, each receiving block of the plurality of receiving blocks corresponding to a respective sub-display region of the plurality of sub-display regions, the method further comprising:
receiving, by the plurality of receiving blocks, the output image data corresponding to the respective sub-display region, and
turning off a receiving block, of the plurality of receiving blocks, corresponding to the same data region in the current frame.

16. The method of claim 13, further comprising:
performing the low power mode operation by turning off at least one component included in a driving controller.

17. The method of claim 16, wherein the driving controller includes a plurality of transmitting blocks, each transmitting block of the plurality of transmitting blocks corresponding to a respective sub-display region of the plurality of sub-display regions, the method further comprising:
transmitting, by each transmitting block of the plurality of transmitting blocks, the output image data corresponding to the respective sub-display region of the plurality of sub-display regions, to the data driver, and
turning off a transmitting block, of the plurality of transmitting blocks, corresponding to the same data region the current frame.

18. The method of claim 13, further comprising:
transmitting, by a driving controller in a blank period of the previous frame, a plurality of protocol signals, each protocol signal of the plurality of protocol signals corresponding to a respective sub-display region of the plurality of sub-display regions, to the data driver of the display device through data transmitting lines for transmitting the output image data corresponding to each sub-display region of the plurality of sub-display regions in a blank period of the previous frame, and
wherein each protocol signal of the plurality of protocol signals includes a low power mode entrance signal and a low power mode termination signal indicating whether to perform the low power mode operation for a respective sub-display region of the plurality of sub-display regions in the current frame.

19. The method of claim 18, wherein the performing the low power mode operation includes performing the low power mode operation for a first target sub-display region, of the plurality of sub-display regions, corresponding to the low power mode entrance signal having an activation level, and the method further comprises:
terminating the low power mode operation for a second target sub-display region, of the plurality of sub-display regions, corresponding to the low power mode termination signal having the activation level in the current frame.

20. An electronic device comprising:
a display panel including pixels;
a gate driver configured to output a gate signal to the pixels through a gate line extending in a first direction;
a data driver configured to output a data voltage to the pixels through a data line extending in a second direction;
a driving controller configured to control the gate driver and the data driver based on a control signal and an input image data group; and
a processor configured to generate the control signal and the input image data group,
wherein the driving controller is further configured to
determines a same data region, of a sub-display region of a plurality of sub-display regions of the display panel parallel to the second direction, in which output image data of a previous frame is identical to output image data of a current frame, and
perform a low power mode operation which does not transmit the output image data corresponding the same data region to the data driver in the current frame.
